(19) United States
(12) Patent Application Publication
(10) Pub. No.: US 2025/0167426 A1
(43) Pub. Date: May 22, 2025

(54) ELECTRONIC DEVICE

(71) Applicant: COMPAL ELECTRONICS, INC., Taipei City (TW)

(72) Inventors: Yan-Ming Lin, Taipei City (TW); Chih-Heng Lin, Taipei City (TW); Yen-Hao Yu, Taipei City (TW); Shih-Chia Liu, Taipei City (TW); Yu-Hui Yeh, Taipei City (TW); Hung-Yu Yeh, Taipei City (TW); Jui-Hung Lai, Taipei City (TW); Yu-Chun Hsieh, Taipei City (TW); Chih-Sheng Yao, Taipei City (TW); Chih-Chiang Wang, Taipei City (TW)

(73) Assignee: COMPAL ELECTRONICS, INC., Taipei City (TW)

(21) Appl. No.: 18/950,141

(22) Filed: Nov. 17, 2024

Related U.S. Application Data
(60) Provisional application No. 63/601,757, filed on Nov. 22, 2023.

(51) Int. Cl. H01Q 1/22; H01Q 1/48

(52) U.S. Cl. CPC H01Q 1/2266; H01Q 1/48

(57) ABSTRACT

An electronic device includes a first housing, a second housing, an antenna module and a conductive elastomer. The second housing is connected to the first housing. The antenna module includes a circuit board. The circuit board has a first surface and a second surface opposite to each other. The first surface faces the first housing and is provided with an antenna pattern. The antenna pattern includes a radiating portion and a grounding portion. The conductive elastomer is located between the antenna module and the first housing. One end of the conductive elastomer is connected to the grounding portion, and the other end of the conductive elastomer is connected to the grounding plane of the first housing.

### CROSS-REFERENCE TO RELATED APPLICATION

This application claims the priority benefit of U.S. application Ser. No. 63/601,757, filed on Nov. 22, 2023. The entirety of the above-mentioned patent application is hereby incorporated by reference herein and made a part of this specification.

### BACKGROUND

### Technical Field

The disclosure relates to an electronic device, and particularly relates to an electronic device including an antenna module.

### Description of Related Art

Most portable electronic devices such as notebook computers and smartphones on the market have wireless communication functions. Generally, notebook computers are equipped with antenna modules to receive or transmit radio waves. The antenna module may use copper foil or aluminum foil as a conductive component, and is adhered to the chassis through conductive adhesive. However, if there is a misalignment in the position where the copper foil or aluminum foil is attached, it is difficult to remove and reattach it, and it cannot be reused.

Therefore, how to improve the assembly of the conductive component of the antenna module has become one of the problems to be solved in this field.

### SUMMARY

The disclosure provides an electronic device that may improve the assembly yield rate of the antenna module while providing the antenna module with good radiation characteristics.

The electronic device of the disclosure includes a first housing, a second housing, an antenna module, and a conductive elastomer. The second housing is connected to the first housing. The antenna module includes a circuit board, which has a first surface and a second surface opposite to each other, with the first surface facing the first housing and having an antenna pattern disposed thereon. The antenna pattern includes a radiation portion and a grounding portion. The conductive elastomer is located between the antenna module and the first housing. One end of the conductive elastomer is connected to the grounding portion, and the other end of the conductive elastomer is connected to a grounding plane of the first housing.

In an embodiment of the disclosure, the first housing has an inner surface corresponding to the antenna pattern, and the orthogonal projection of the conductive elastomer on the inner surface overlaps with the orthogonal projection of the grounding portion on the inner surface.

In an embodiment of the disclosure, the first housing includes a supporting structure protruding towards the second housing, and the circuit board is disposed on the supporting structure.

In an embodiment of the disclosure, an adhesive layer is disposed between the antenna pattern and the supporting structure.

In an embodiment of the disclosure, the supporting structure is a non-conductor.

In an embodiment of the disclosure, the supporting structure and the first housing are formed integrally.

In an embodiment of the disclosure, the antenna module further includes a base disposed on the second surface, and a locking element penetrates through the base and protrudes on both sides of the circuit board to fix the base to the first housing.

In an embodiment of the disclosure, an adhesive layer is disposed between the base and the second surface of the circuit board.

In an embodiment of the disclosure, the second housing includes a protruding element, the protruding element protrudes from the second housing towards the first housing to approach the second surface.

In an embodiment of the disclosure, the orthographic projection of the protruding element on the inner surface of the first housing overlaps with the orthographic projection of the conductive elastomer on the inner surface of the first housing.

In an embodiment of the disclosure, the protruding element is a non-conductor.

In an embodiment of the disclosure, the first housing is a plastic housing, and is equipped with a conductive sheet to serve as a grounding plane.

In an embodiment of the disclosure, the second housing is a plastic housing.

In an embodiment of the disclosure, the electronic device further includes a first body and a second body pivotally connected to each other, wherein the second body is a logic unit, and the first body is a display unit and includes the first housing and the second housing.

In an embodiment of the disclosure, the width of the connection between the conductive elastomer and the grounding portion is not less than 2 millimeters.

In an embodiment of the disclosure, the height of the conductive elastomer must be compressed by not less than 30%.

Based on the above, in the electronic device of the disclosure, the conductive elastomer is positioned between the antenna module and the first housing, and the conductive elastomer and the antenna pattern on the circuit board are disposed on the same surface. This conductive elastomer is used to replace copper or aluminum foil as a grounding component for grounding conduction with the grounding plane of the first housing, and the problem of copper or aluminum foil directly connected to the grounding portion of the circuit board being attached incorrectly and difficult to re-adhere may be avoided thereby.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a perspective view of an electronic device according to an embodiment of the disclosure.

FIG. 2A is an exploded view of an electronic device according to an embodiment of the disclosure.

FIG. 2B is a cross-sectional view of the first body in FIG. 2A.

FIG. 2C is a schematic view of the antenna module in FIG. 2A.

FIG. 3 is a cross-sectional view of an electronic device according to an embodiment of the disclosure.

FIG. 4A is an exploded view of an electronic device according to an embodiment of the disclosure.

FIG. 4B is a cross-sectional view of the electronic device in FIG. 4A.

FIG. 5 is a cross-sectional view of an electronic device according to an embodiment of the disclosure.

### DESCRIPTION OF THE EMBODIMENTS

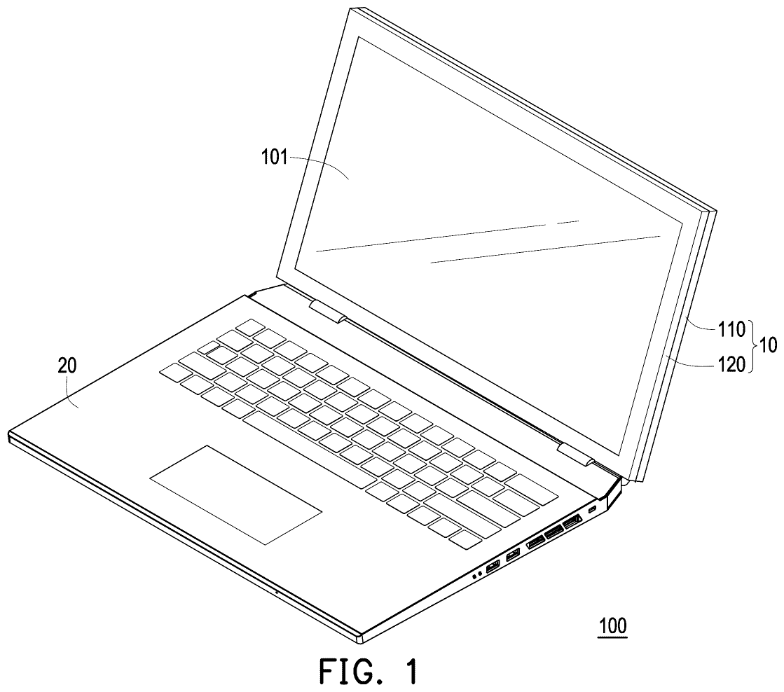

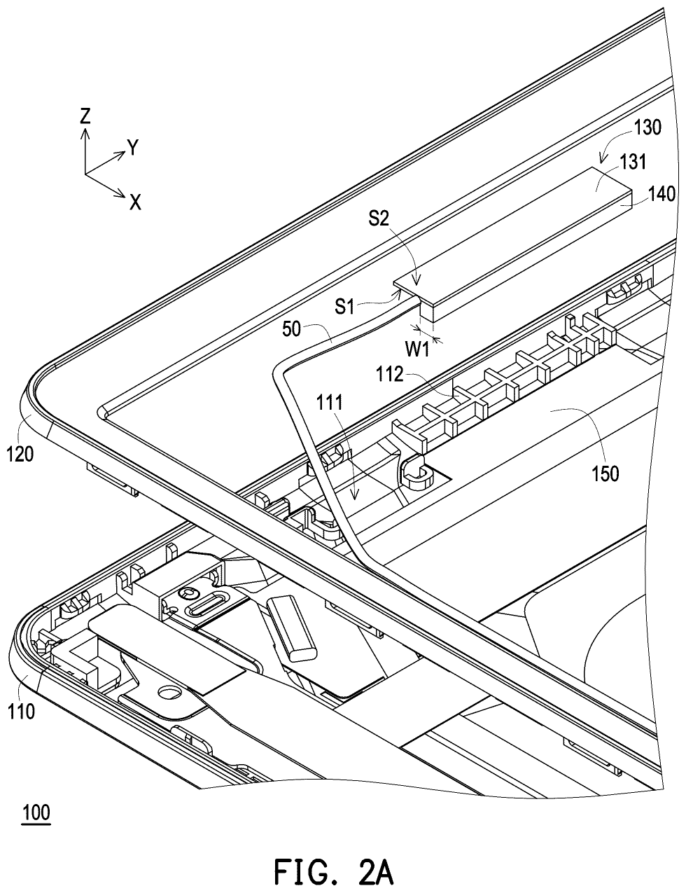

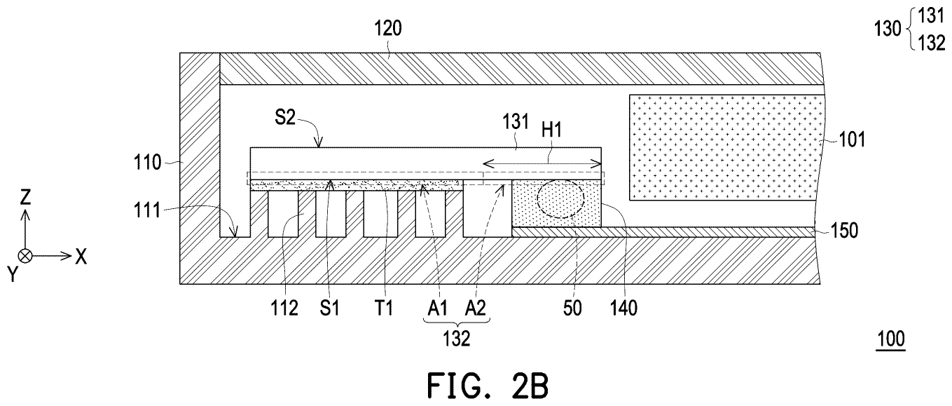

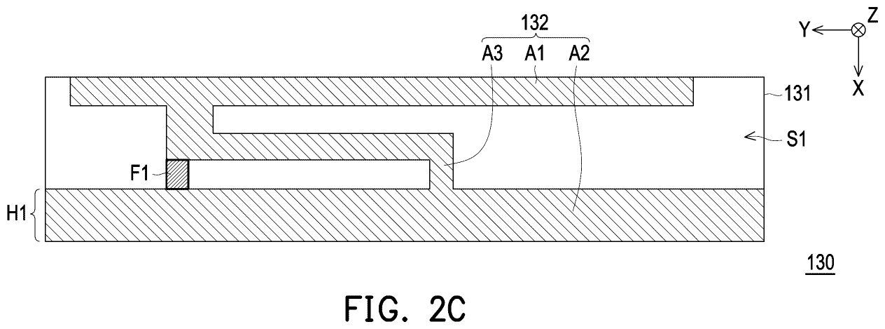

FIG. 1 is a perspective view of an electronic device according to an embodiment of the disclosure. FIG. 2A is an exploded view of an electronic device according to an embodiment of the disclosure. FIG. 2B is a cross-sectional view of the first body in FIG. 2A. FIG. 2C is a schematic view of the antenna module in FIG. 2A. It should be noted that the electronic device shown in FIG. 1 is only a simplified schematic representation for reference purposes. In FIG. 2A to FIG. 2C, a rectangular coordinate system X-Y-Z is provided to facilitate component identification, and some non-relevant structures may be omitted to facilitate the display and identification of the components that need to be explained.

Referring to FIG. 1, the electronic device 100 of this example includes a first body 10 and a second body 20 that are pivotally connected to each other. In this embodiment, the electronic device 100 is a notebook computer, but the type of the electronic device 100 is not limited thereto. In other examples, the electronic device 100 may also be a tablet computer, but is not limited thereto.

In this embodiment, the second body 20 is a logic unit, and the first body 10 is a display unit that includes a first housing 110 and a second housing 120. The second housing 120 is connected to the first housing 110. Specifically, the first housing 110 is the back plate of the display unit, and the display screen 101 of the electronic device 100 is configured inside the first housing 110. The display surface of the display screen 101 faces away from the first housing 110. The second housing 120 is assembled onto the first housing 110 and covers the periphery of the display screen 101 to serve as a display bezel and to fix it, but the disclosure is not limited thereto.

Please refer to FIG. 2A and FIG. 2B. In this embodiment, the electronic device 100 further includes an antenna module 130 and a conductive elastomer 140. Here, the conductive elastomer 140 may be a conductive foam or a conductive fabric over foam, but the disclosure is not limited thereto.

In this embodiment, the antenna module 130 includes a circuit board 131. The circuit board 131 has a first surface S1 and a second surface S2 opposite to each other. The first surface S1 faces the first housing 110 and is disposed with an antenna pattern 132 thereon. The antenna pattern 132 includes a radiation portion A1 and a grounding portion A2, but the disclosure is not limited thereto. The grounding portion A2 is located between the radiation portion A1 and the display screen 101. The grounding portion A2 is closer to the display screen 101 compared to the radiation portion A1, but the disclosure is not limited thereto. It should be noted that in FIG. 2B, the relative positions of the radiation portion A1 and the grounding portion A2 are represented by dashed boxes. Their conductive patterns can be appropriately designed according to actual needs, and the disclosure is not limited thereto.

In an embodiment, the width W1 (FIG. 2A) of the connection between the conductive elastomer 140 and the grounding portion A2 may not be less than 2 millimeters, but the disclosure is not limited thereto. The width W1 may be parallel to the X direction, but the disclosure is not limited thereto. In an embodiment, the high compression amount of the conductive elastomer 140 in the Z direction may not be less than 30%, but the disclosure is not limited thereto.

In an embodiment, please refer to FIG. 2C, the antenna pattern 132 further includes a shorting portion A3. The shorting portion A3 connects the radiation portion A1 and the grounding portion A2, but the disclosure is not limited thereto. In this embodiment, a feeding point F1 is fed by a coaxial cable 50 (FIG. 2B), but in other embodiments, the layout of the antenna pattern 132 may be appropriately adjusted according to the actual required transmitting and receiving frequencies. As long as the antenna pattern 132 is located on the first surface S1 and faces the first housing 110, it falls within the scope of the disclosure, and the disclosure is not limited thereto. Here, the length H1 of the grounding portion A2 in the X direction is at least greater than 2 millimeters, to be suitable for connection with the conductive elastomer 140, but the disclosure is not limited thereto.

Please refer to FIG. 2B. In this embodiment, the conductive elastomer 140 is located between the antenna module 130 and the first housing 110. The thickness of the conductive elastomer 140 in the Z direction is at least greater than 2 millimeters, but the disclosure is not limited thereto. One end of the conductive elastomer 140 is connected to the grounding portion A2, and the other end of the conductive elastomer 140 is connected to the grounding plane of the first housing 110.

Specifically, in this embodiment, the first housing 110 has an inner surface 111 corresponding to the antenna pattern 132. The circuit board 131 is parallel to the inner surface 111. The orthogonal projection of the conductive elastomer 140 on the inner surface 111 overlaps with the orthogonal projection of the grounding portion A2 on the inner surface 111.

In this embodiment, the first housing 110 is a plastic housing and is equipped with a conductive sheet 150 to serve as a grounding plane, but the disclosure is not limited thereto. Here, the conductive sheet 150 may be an aluminum foil or copper foil that is already present on the display screen 101, or an aluminum foil or a copper foil that is already disposed on the first housing 110. The disclosure is not limited thereto. Therefore, there is no need to add additional aluminum foil or copper foil on the antenna module 130.

Under the above configuration method, the antenna module 130 is composed of the circuit board 131, the conductive elastomer 140, and the coaxial cable 50, wherein the conductive elastomer 140 and the antenna pattern 132 on the circuit board 131 are disposed on the same surface, that is, on the first surface S1. As a result, the grounding portion A2 of the antenna module 130 may utilize the conductive elastomer 140 as a grounding component to conduct with the grounding plane of the first housing 110. The advantage of this design is that it eliminates the traditional method of directly connecting copper foil or aluminum foil to the grounding portion of the antenna and then adhering the copper foil or aluminum foil to the chassis, thereby avoiding the problem of incorrect adhesion and difficulty in re-adhering. The electronic device of this embodiment may improve assembly yield rate and convenience while providing the antenna module with good radiation characteristics.

More specifically, please refer to FIG. 2B. In this embodiment, the first housing 110 includes a supporting structure 112 protruding towards the second housing 120. Here, the supporting structure 112 is a non-conductor, for example, it is made of plastic material, but is not limited thereto. In one embodiment, the supporting structure 112 and the first housing 110 are formed integrally, but the disclosure is not limited thereto.

In this embodiment, the circuit board 131 is disposed on the supporting structure 112. Specifically, the first surface S1 contacts the supporting structure 112. When the inner surface 111 of the first housing 110 is uneven, it may be corrected through the supporting structure 112 to facilitate the positioning of the circuit board 131 and ensure a stable abutting relationship between the first surface S1 and the conductive elastomer 140. Moreover, since the supporting structure 112 protrudes from the inner surface 111 of the first housing 110, it can lift up the circuit board 131, creating a gap between the circuit board and the inner surface 111, which makes it easier to retrieve the circuit board 131 during maintenance.

Furthermore, in this embodiment, an adhesive layer T1 is disposed between the antenna pattern 132 and the supporting structure 112 to enhance the fixation of the circuit board 131. In other embodiments, the circuit board 131 and the supporting structure 112 may also be connected in other appropriate methods, and the disclosure is not limited thereto.

In addition, please refer to FIG. 2A. In this embodiment, the conductive elastomer 140 is fixed on the first surface S1 using conductive adhesive. However, in other embodiments, the conductive elastomer 140 may also be fixed on the grounding plane of the first housing 110 using conductive adhesive. The disclosure is not limited thereto.

The following will list other embodiments for illustration. It must be explained here that the following embodiments reuse the component labels and partial content from the aforementioned embodiments, where the same labels are used to represent the same or similar components, and explanations of identical technical content are omitted. For explanations of the omitted parts, please refer to the previous embodiments, and the following embodiments would not repeat these explanations.

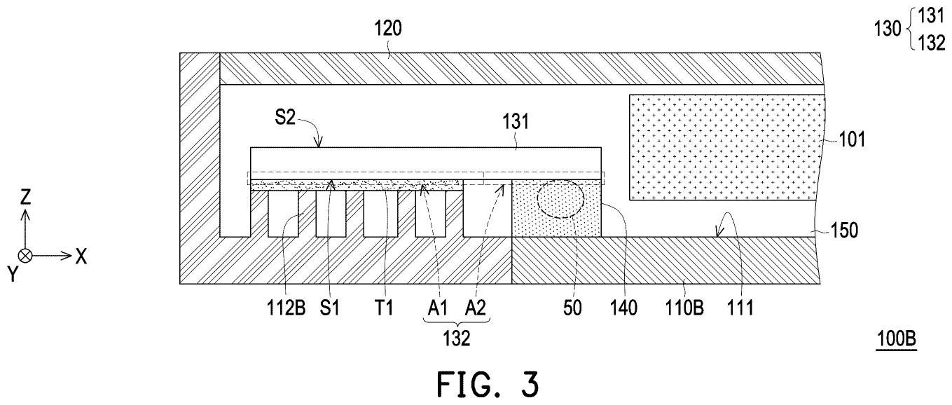

FIG. 3 is a cross-sectional view of an electronic device according to an embodiment of the disclosure. Please refer to FIG. 3. In this embodiment, the electronic device 100B is slightly different from the electronic device 100 in FIG. 2B. The main difference is that in this embodiment, the first housing 110B is a metal housing, and the first housing 110B and the plastic supporting structure 112B are manufactured using insert molding or bonding, but the disclosure is not limited thereto. As a result, the grounding portion A2 of the antenna module 130 may utilize the conductive elastomer 140 for grounding conduction with the metal first housing 110B.

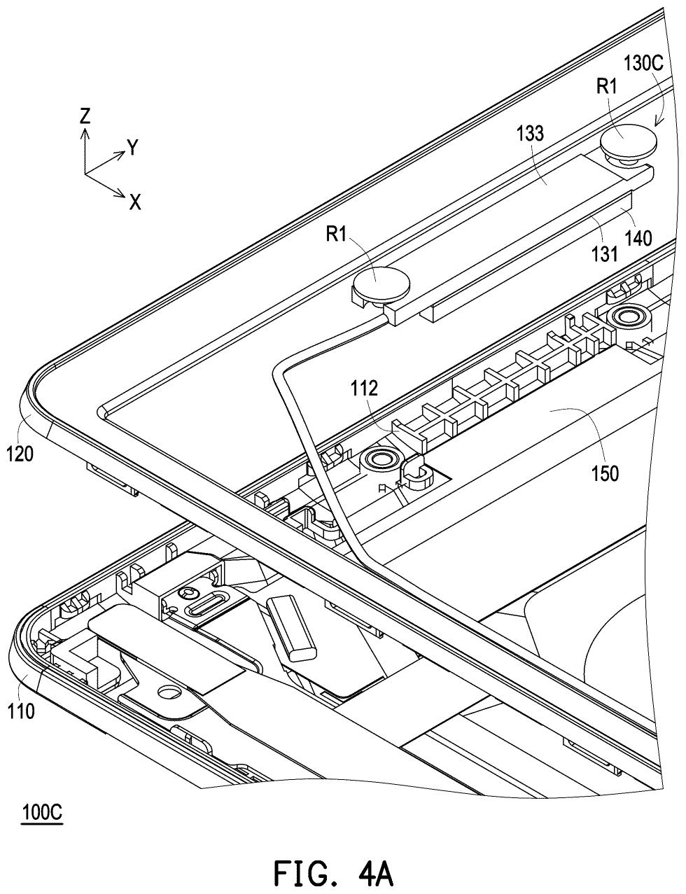

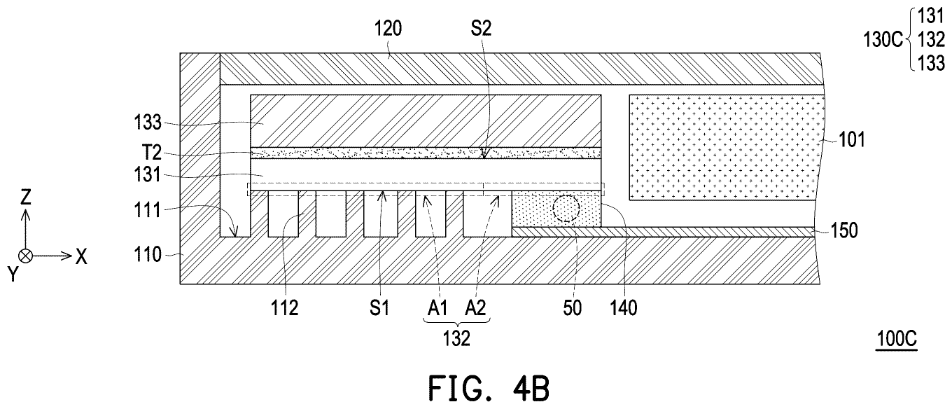

FIG. 4A is an exploded view of an electronic device according to an embodiment of the disclosure. FIG. 4B is a cross-sectional view of the electronic device in FIG. 4A. Please refer to FIG. 4A and FIG. 4B. In this embodiment, the electronic device 100C is slightly different from the electronic device 100 in FIG. 2B. The main difference is that: the antenna module 130C further includes a base 133, disposed on the second surface S2. At least one locking element R1 passes through the base 133 and protrudes from opposite two sides of the circuit board 131 to fix the base 133 to the first housing 110. However, in other embodiments, the fixing method between the base 133 and the first housing 110 may also be snap-fit, riveting, or adhesive bonding, etc. The disclosure is not limited thereto. Here, the base 133 is a non-conductor, with a material such as plastic, but the disclosure is not limited thereto.

In this embodiment, an adhesive layer T2 is disposed between the base 133 and the second surface S2 of the circuit board 131, so that the base 133 can be more firmly pressed against the circuit board 131. In other embodiments, the circuit board 131 and the base 133 may also be connected in other appropriate methods. The disclosure is not limited thereto.

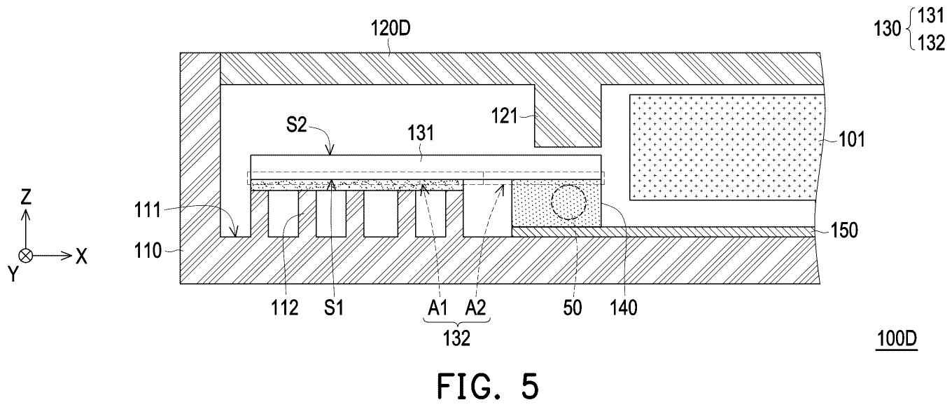

FIG. 5 is a cross-sectional view of an electronic device according to an embodiment of the disclosure. Please refer to FIG. 5. In this embodiment, the electronic device 100D is slightly different from the electronic device 100 in FIG. 2B. The main difference is that: the second housing 120D includes a protruding element 121, which protrudes from the second housing 120 towards the first housing 110 to approach the second surface S2. In one example, the protruding element 121 may also directly contact the second surface S2 to enhance the force which the antenna module 130 presses against the conductive elastomer 140. The disclosure is not limited thereto.

In this embodiment, the orthogonal projection of the protruding element 121 on the inner surface 111 of the first housing 110 overlaps with the orthogonal projection of the conductive elastomer 140 on the inner surface 111 of the first housing 110. As a result, the protruding element 121 may be used to limit the position of the antenna module 130, to prevent the antenna module 130 from bouncing up due to the conductive elastomer 140.

In this embodiment, the second housing 120 is a plastic housing, but is not limited thereto. In this embodiment, the protruding element 121 is a non-conductor, for example, made of plastic material, but is not limited thereto. In one example, the protruding element 121 and the second housing 120 may be formed integrally, but the disclosure is not limited thereto.

In summary, in the electronic device of the disclosure, the conductive elastomer is located between the antenna module and the first housing, and the conductive elastomer and the antenna pattern on the circuit board are disposed on the same surface. This conductive elastomer is used instead of copper or aluminum foil as a grounding component for grounding conduction with the grounding plane of the first housing. The advantage of this design is that it eliminates the traditional process of directly connecting copper foil or aluminum foil to the grounding portion of the antenna module and then adhering the copper foil or aluminum foil to the chassis, thereby avoiding the problem of incorrect adhesion and difficulty in re-adhering. The electronic device of the disclosure may improve assembly yield rate and convenience, while also providing the antenna module with good radiation characteristics.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A electronic device, comprising:
a first housing;
a second housing, connected to the first housing;
an antenna module, comprising a circuit board, the circuit board having a first surface and a second surface opposite to each other, the first surface facing the first housing and having an antenna pattern, the antenna pattern comprising a radiation portion and a grounding portion; and
a conductive elastomer, located between the antenna module and the first housing, one end of the conductive elastomer connected to the grounding portion, and the other end of the conductive elastomer connected to a grounding plane of the first housing.

2. The electronic device as claimed in claim 1, wherein the first housing has an inner surface corresponding to the antenna pattern, and an orthographic projection of the conductive elastomer on the inner surface overlaps with an orthographic projection of the grounding portion on the inner surface.

3. The electronic device as claimed in claim 1, wherein the first housing comprises a supporting structure protruding towards the second housing, and the circuit board is configured on the supporting structure.

4. The electronic device as claimed in claim 3, wherein an adhesive layer is disposed between the antenna pattern and the supporting structure.

5. The electronic device as claimed in claim 3, wherein the supporting structure is a non-conductor.

6. The electronic device as claimed in claim 3, wherein the supporting structure and the first housing are formed integrally.

7. The electronic device as claimed in claim 1, wherein the antenna module further comprises a base, disposed on the second surface, a locking element passing through the base and protruding from opposite two sides of the circuit board, to fix the base to the first housing.

8. The electronic device as claimed in claim 7, wherein an adhesive layer is disposed between the base and the second surface of the circuit board.

9. The electronic device as claimed in claim 1, wherein the second housing comprises a protruding element, the protruding element protruding from the second housing towards the first housing to approach the second surface.

10. The electronic device as claimed in claim 9, wherein an orthographic projection of the protruding element on the inner surface of the first housing overlaps with an orthographic projection of the conductive elastomer on the inner surface of the first housing.

11. The electronic device as claimed in claim 9, wherein the protruding element is a non-conductor.

12. The electronic device as claimed in claim 1, wherein the first housing is a plastic housing, and is equipped with a conductive sheet to serve as the grounding plane.

13. The electronic device as claimed in claim 1, wherein the second housing is a plastic housing.

14. The electronic device as claimed in claim 1, further comprising a first body and a second body pivotally connected to each other, wherein the second body is a logic unit, and the first body is a display unit comprising the first housing and the second housing.

15. The electronic device as claimed in claim 1, wherein the width of the connection between the conductive elastomer and the grounding portion is not less than 2 millimeters.

16. The electronic device as claimed in claim 1, wherein the high compression amount of the conductive elastomer is not less than 30%.
